(19) United States
(12) Patent Application Publication
(10) Pub. No.: US 2018/0045228 A1
(43) Pub. Date: Feb. 15, 2018

(54) CYLINDER/PISTON UNIT

(71) Applicant: Otto Nussbaum GmbH & Co. KG, Kehl-Bodersweier (DE)

(72) Inventors: Hans Nussbaum, Kehl-Bodersweier (DE); Steffen Nussbaum, Kehl-Bodersweier (DE); Ludwig Huber, Kehl-Bodersweier (DE); Werner Scheidecker, Kehl-Bodersweier (DE)

(73) Assignee: Otto Nussbaum GmbH & Co. KG, Kehl-Bodersweier (DE)

(21) Appl. No.: 15/556,132

(22) PCT Filed: Feb. 29, 2016
(86) PCT No.: PCT/EP2016/054238

§ 371 Date: Sep. 6, 2017

(30) Foreign Application Priority Data
Mar. 6, 2015 (EP) 15158120.4

(51) Int. Cl. F15B 15/14; F15B 11/22; F15B 11/036; F15B 11/20; B66F 7/06; B66F 7/08

(52) U.S. Cl. CPC F15B 15/1466; B66F 7/065; B66F 7/08; F15B 11/036; F15B 11/205; F15B 11/22; F15B 20/00

(57) ABSTRACT

The problem of providing a cylinder/piston unit which can be installed in a relatively space-saving manner, in particular, for use in a master/slave arrangement is solved by virtue of the fact that a first, outer hydraulic cylinder (2) is provided, in which a first piston (6) is mounted sealingly with respect to the cylinder inner wall of the first hydraulic cylinder (2) and longitudinally movable in the latter, and the first piston (6) supports a second, inner hydraulic cylinder (3), in which a second piston (9) is mounted sealingly with respect to the cylinder inner wall of the second hydraulic cylinder (3) and longitudinally movable in the latter. The second, inner hydraulic cylinder (3) supports a piston rod (10), and the piston rod (10) is connected at the end thereof which is remote from the second piston (9) to an end (4) of the outer hydraulic cylinder (2).

### BACKGROUND

The present invention relates to a cylinder/piston unit, which can be used for example in a hoisting platform.

The cylinder unit comprises generally a hydraulic cylinder in which a piston is supported in a sealing fashion in reference to the cylinder wall of the hydraulic cylinder and is longitudinally mobile therein. The piston therefore divides the cylinder into two cylinder chambers on the two sides of the piston. When a pressure is applied upon one of the two cylinder chambers, the piston is moved inside the cylinder, with the hydraulic means present in the other cylinder chamber being displaced, with it here being mandatory that it can drain through an appropriate hydraulic connection.

A scissors-type hoist with two separate, hydraulically operated scissor-like frames is known from the publication DE 29916254 U1, for example. Each of the two scissor-like frames shows two parallel arranged and synchronized cylinder/piston units. One cylinder/piston unit of each unit pair serves as a command unit and is hydraulically coupled to the second cylinder/piston unit of the other unit pair, acting as a downstream unit. Such a command/downstream arrangement and/or master-slave arrangement of cylinder/piston units is advantageous in that two separate hydraulic circuits are given such that in the event of any leakage or a brake of one hydraulic line the hoisting platform is not lowered, because the unit of the second hydraulic circuit, not affected by the defect, assumes the holding function of the extended unit for both scissor-like frames.

In such a hydraulic unit it is disadvantageous that in order to maintain the required redundancy the number of cylinder/piston units must be doubled and each cylinder/piston unit must be arranged in pairs and coupled to one another. This increases not only the production costs, but requires a considerably larger structural space compared to a single cylinder/piston unit in order to accept the respective pair of units.

### SUMMARY

The objective of the present invention comprises to provide a cylinder/piston unit which can be installed in a space-saving fashion particularly for the use in a master/slave unit.

The objective is attained in the features of the below described invention. Advantageous embodiments are discernible from the dependent claims Furthermore the invention also relates to a hydraulic arrangement with two such cylinder/piston units connected to a master/slave arrangement as well as a lifting hoist comprising such a hydraulic arrangement. Another preferred application of the cylinder/piston unit is directed to a further hydraulic arrangement according to the invention.

A compact structure according to the invention is yielded in a cylinder/piston unit such that a first, external hydraulic cylinder is provided, in which a first piston is supported in a sealing fashion in reference to the cylinder inner wall of the first hydraulic cylinder and is longitudinally mobile inside thereof, with this first piston carrying a second, inner hydraulic cylinder in which a second piston is supported in a sealing fashion in reference to the inner cylinder wall of the second hydraulic cylinder and is longitudinally mobile inside thereof, which carries a piston rod, with the piston rod being connected at its end distant from the second piston with an end of the external hydraulic cylinder.

This way, two separate hydraulic cylinders are integrated coaxially and by a mechanic coupling of the outer hydraulic cylinder to the piston rod of the inner hydraulic cylinder here synchronization is mandated. The pistons of both the inner as well as the outer hydraulic cylinder can only be moved if the respectively other piston also moves by the same length of stroke.

Here it is essential that the hydraulically effective area of the first piston is adjusted on its side facing the second hydraulic cylinder to the hydraulically active area of the second piston on its side facing away from the piston rod. This way, in case of an upward motion of the piston of the outer hydraulic cylinder the same volume of hydraulic means is displaced as must be supplied to the second hydraulic cylinder for a motion about the same length of stroke. By this measure it is possible to directly connect in a fluid-guiding fashion the first hydraulic cylinder to the second one of the same or a different cylinder/piston unit. Cylinder/piston units according to the invention can therefore be switched to form a master/slave arrangement in order to yield synchronous strokes of these cylinders.

In a preferred embodiment the piston rod can extend through a first piston in a longitudinally mobile fashion and sealing in reference to said piston. The piston of the outer hydraulic cylinder is therefore embodied in an annular fashion and comprises an outer piston gasket in reference to the inner cylinder wall of the hydraulic cylinder as well as an inner piston gasket in reference to the piston rod. The piston rod is here connected stiffly to the bottom of the outer hydraulic cylinder.

In an advantageous variant of the present invention it is provided that the first and the second hydraulic cylinder comprise each in the area of the respectively corresponding end position of the first and/or second piston an overflow channel. Hydraulic means from the pressurized cylinder chamber at one side of the respective piston can travel via the overflow channel to a cylinder chamber located on the respectively other side of the respective piston or directly to a hydraulic connection directly connected thereto. Serving as an overflow channel may be here a targeted leakage, for example a groove arranged in the area of the aforementioned end position at the interior of the cylinder wall, through which the hydraulic means can flow past the piston gasket of the respective piston. Such an overflow channel shows advantageous effects in many aspects. On the one hand, the overflow channel allows in a master/slave arrangement the compensation of minor stroke differences between the master and slave cylinders based on leakages or thermal differences. Additionally, by the overflow of the hydraulic means in the proximity of the end position the force applied upon the piston is reduced such that the piston movement in the proximity of the end position is gently braked.

In another embodiment of the present invention the piston rod comprises at least one longitudinal bore hole, through which a hydraulic connection extends to the second hydraulic cylinder. In particular, the hydraulic connection extending through the longitudinal bore hole can be connected to the cylinder chamber which is located at the side of the piston facing away from the piston rod. This way the supply lines for the hydraulic means can be arranged at the same side of the cylinder/piston unit for the outer as well as the inner hydraulic cylinder. Additionally it is possible to connect this or another longitudinal bore hole in the piston rod also to the cylinder chamber of the second hydraulic cylinder located at the opposite piston side and to provide a respective second hydraulic connection. It serves in the aforementioned case as a drain for the hydraulic means via which the hydraulic means displaced by the piston in a stroke motion can be drained.

In a preferred hydraulic arrangement two cylinder/piston units according to the invention are switched to form a command/downstream arrangement and/or master/slave arrangement by the first and the second hydraulic cylinder of the two cylinder/piston units respectively being connected crosswise to each other in a fluid-conducting fashion such that here the second hydraulic cylinder operates as a slave cylinder of the first hydraulic cylinder of the respectively other cylinder piston/unit.

In particular, in such a hydraulic arrangement it is provided that a cylinder chamber of the first hydraulic cylinder of a first of the two cylinder/piston units is connected in a fluid-conducting fashion at the side of its first piston, facing the second hydraulic cylinder, to the cylinder chamber of the second hydraulic cylinder of the second of the cylinder/piston units at the side of a second piston facing away from the piston rod.

Such a master/slave arrangement of cylinder/piston units according to the invention can be used advantageously in a hoisting platform, particularly a scissor-like hoist, in which the two cylinder/piston units connected to the master/slave arrangement in a fluid-conducting fashion are allocated to two separate hoisting devices, particularly scissor-like hoists. Similarly, respective cylinder/piston units can be allocated to more than two hoisting units, for example in case of a hoisting platform with four separate hoisting plungers. Instead of a single cylinder/piston unit, connected crosswise to one another to form a master/slave arrangement, the four stroke plungers can also be connected to each other in a ring-like serial connection.

Another advantageous hydraulic arrangement with at least one cylinder/piston unit according to the invention develops when a cylinder chamber of the first hydraulic cylinder is connected in a fluid-conducting fashion at the side of the first piston facing the second hydraulic cylinder to a cylinder chamber of the second hydraulic cylinder at the side of the second piston facing away from the piston rod. In such an arrangement, here called “force cylinder”, the hydraulically active areas of the first and the second piston are added and thus they are able to apply with the same pressure of the hydraulic means the forces to be applied by both coaxially integrated hydraulic cylinders. Thus, with the aforementioned hydraulic arrangement here higher effective forces can be applied than possible with individual hydraulic cylinders showing the same outer diameter. While it is generally assumed in prior art that in order to increase the hydraulic forces cylinders must be used with greater diameters, the “force cylinder” according to the invention allows an increase in force by approximately 50% with identical outer diameters of the cylinders so that it is particularly suited for installation under conditions of limited structural space.

Finally, the invention also relates to an alternative embodiment of two coaxially integrated hydraulic cylinders in a cylinder/piston unit. Here again a first, outer hydraulic cylinder is provided as well as a second inner one. Unlike the first embodiment they are not arranged opposite each other here but connected to each other at the bottom. The outer hydraulic cylinder is here coaxially arranged around the inner hydraulic cylinder. The outer hydraulic cylinder comprises an annular piston which is longitudinally mobile inside the outer hydraulic cylinder in an annular chamber about the inner hydraulic cylinder and is sealed both towards the inner wall of the outer hydraulic cylinder as well as against the outer wall of the inner hydraulic cylinder. The piston of the outer hydraulic cylinder carries a tubular piston rod, with its inner diameter being greater than the outer diameter of the inner hydraulic cylinder. A piston is also located inside the hydraulic cylinder in a longitudinally displaceable fashion and sealed towards the inner wall of the inner hydraulic cylinder. The piston of the inner hydraulic cylinder in turn carries a piston rod which is connected at its end, distant from the piston, to the end of the tubular piston rod of the outer hydraulic cylinder. This way, the inner and the outer hydraulic cylinder are also mandatorily synchronized with each other and serve as redundant units of the cylinder/piston unit.

### BRIEF DESCRIPTION OF THE DRAWINGS

In the following, additional features, advantages, and characteristics of the present invention are explained based on the figures and exemplary embodiments. Shown are:

FIG. 1 a longitudinal cross-section through a cylinder/piston unit according to the invention,

FIG. 2 an enlarged view of a detail A of FIG. 1,

FIG. 3 an enlarged view of a detail B of FIG. 1,

FIG. 4 an enlarged view of a detail C of FIG. 1,

FIG. 5 a view of the cylinder/piston unit of FIG. 1 from the bottom, and

FIG. 6 a schematic connection of two cylinder/piston units according to the invention to form a master/slave arrangement.

### DETAILED DESCRIPTION OF THE PREFERRED EMBODIMENTS

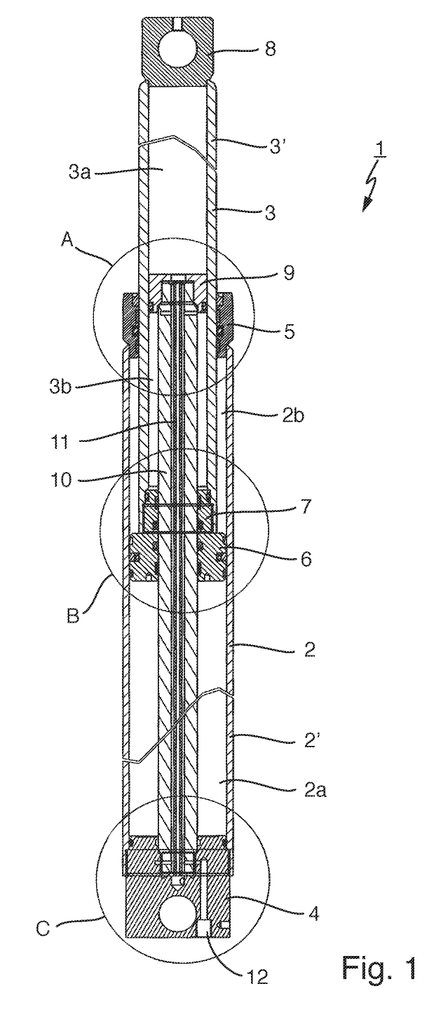

FIG. 1 shows an exemplary embodiment of a cylinder/piston unit 1 with two coaxially integrated hydraulic cylinders 2, 3. The cylinder/piston unit 1 comprises an outer hydraulic cylinder 2 with a cylinder tube 2′, which is closed at one side with a bottom end piece 4, on the other side comprises an annular cylinder head. A piston 6 is arranged in the outer hydraulic cylinder 2, mobile in the longitudinal direction, which divides the hydraulic cylinder 2 into a lower cylinder chamber 2a and an upper cylinder chamber 2b. Both cylinder chambers 2a, 2b are filled with hydraulic fluid and each comprises a hydraulic connection, not shown in the figure, via which the hydraulic means can be supplied to the respective cylinder chamber or drained therefrom.

The piston 6 carries on its in the figure upper side the inner hydraulic cylinder 3. The inner hydraulic cylinder 3 comprises a cylinder tube 3′, a cylinder head 7 arranged at its lower side, and an upper end part 8.

The cylinder head 7 is embodied annularly and connected fixed to the piston 6. A piston 9 is arranged in a longitudinally mobile fashion inside the inner cylinder 3 and divides the cylinder 3 into an upper cylinder chamber 3a and a cylinder chamber 3b. The piston 9 comprises a piston rod 10, which in the figure is aligned downwards in the direction to the outer hydraulic cylinder 2. The piston rod 10 extends through the annular cylinder head 7 and through a central bore hole of the piston 6 of the outer hydraulic cylinder into the lower cylinder chamber 2a of the outer hydraulic cylinder 2 and ends at the bottom of the hydraulic cylinder 2, where it is connected stiffly with the end piece 4. The piston rod 10 is sealed via appropriate gaskets towards the annular cylinder head 7 of the inner cylinder 3 and the piston 6 of the outer cylinder 2.

The piston rod 10 comprises a longitudinal bore hole through which a hydraulic line 11 is guided, which connects the cylinder chamber above the piston 9 to a hydraulic connection (not shown) provided at an end piece 4 at the bottom of the outer cylinder 2. The cylinder chamber 3b below the piston 9 is also connected via a radially extending bore hole in the piston rod 10 to its longitudinal bore hole such that the hydraulic fluid can flow into the annular chamber about the hydraulic line 11 through the longitudinal bore hole of the piston rod 10 to a second hydraulic connection 12 in the end piece 4 of the outer hydraulic cylinder 2.

The function of the cylinder/piston unit 1 is as follows: When the lower cylinder chamber 2a of the outer hydraulic cylinder 2 is impinged with pressure, the piston 6 is pushed downwards and displaces hydraulic fluid in the upper cylinder chamber 2b, which must flow out to an appropriate hydraulic connection (not shown). Simultaneously however the piston 9 of the inner hydraulic cylinder 3 must also be moved downwards, because its piston rod 10 is linked stiffly to the bottom of the outer hydraulic cylinder 2. For this purpose, the upper cylinder chamber 3a of the inner cylinder 23 is also impinged hydraulically with pressure via the hydraulic line 11 guided through the piston rod 10. This way the piston 9 is pushed downwards in the figure and displaces the hydraulic fluid in the lower cylinder chamber 3b of the inner cylinder 3, which can drain through the longitudinal bore hole in the piston rod 10 to the hydraulic connection 12 in the end piece 4 at the bottom of the outer hydraulic cylinder 2.

The hydraulic cylinders show the following dimensions in the exemplary embodiment, without the invention being limited thereto: The outer hydraulic cylinder 2 shows an inner diameter of 75 mm. The inner hydraulic cylinder shows an inner diameter of 45 mm with an outer diameter of 60 mm. The piston rod 10 has an outer diameter of 30 mm with a longitudinal bore hole showing a diameter of 10 mm. This way, the stroke lengths of approximately 600 mm can be realized. For greater stroke lengths up to approx. 2000 m here a piston rod of 40 mm diameter is used with an inner bore hole of 15 mm.

This way, in the exemplary embodiment the hydraulically acting areas of the piston 6 at the upper side, facing the cylinder chamber 2b, and the piston 9 at its side facing the upper cylinder chamber 3a of the inner hydraulic side 3 are adjusted to one another and/or match each other. Thus, the piston 6 displaces during its upwards motion the same amount of hydraulic means as must be supplied to the upper cylinder chamber 3a of the inner hydraulic cylinder during a respective downwards motion of the piston 9. The hydraulic connections of the cylinder chamber 2b and the cylinder chamber 3a of the outer and/or inner hydraulic cylinders can therefore be connected directly to each other. In this case, the hydraulically active areas of the bottom of the piston 6 facing the cylinder chamber 2a and the top of the piston 9 facing the cylinder chamber 3a are added. This way the hydraulically effective total area of the pistons 6 and 9 combined is greater than the inner cross-section of the outer hydraulic cylinder 2, so that overall under the same hydraulic pressure here a greater force can be applied than possible in case of a single hydraulic cylinder showing the dimensions of the outer cylinder 2. In this hydraulic design the cylinder/piston unit 1 is therefore operated as a “force cylinder”.

Both the inner as well as the outer hydraulic cylinder 2, 3 each comprise an overflow channel in the proximity of the end position of their pistons 6, 9 namely preferably in the proximity of the end position, in which the cylinder/piston unit is maximally extended. In the exemplary embodiment a longitudinal groove at the inside of the cylinder wall 2′ and/or 3′ serves as the overflow channel in the proximity of the aforementioned end position, by which hydraulic fluid can flow past the piston gasket of the respective piston 6, 9 located in the end position out of the cylinder chamber 2a and/or 3a to the cylinder chamber 2b and/or 3b located at the respectively other side of the piston 6, 9 and further to the hydraulic connection connected to said cylinder chamber 2b and/or 3b.

When the two cylinder/piston units 1 according to the invention are connected to form a master/slave arrangement here the overflow channel allows a compensation of minor gear differences between the master and the slave cylinder due to leakage or thermal differences. Additionally, the overflow channel simultaneously acts as an end position damper, because by the overflow of hydraulic fluid in the proximity of the end position the force acting upon the piston is reduced.

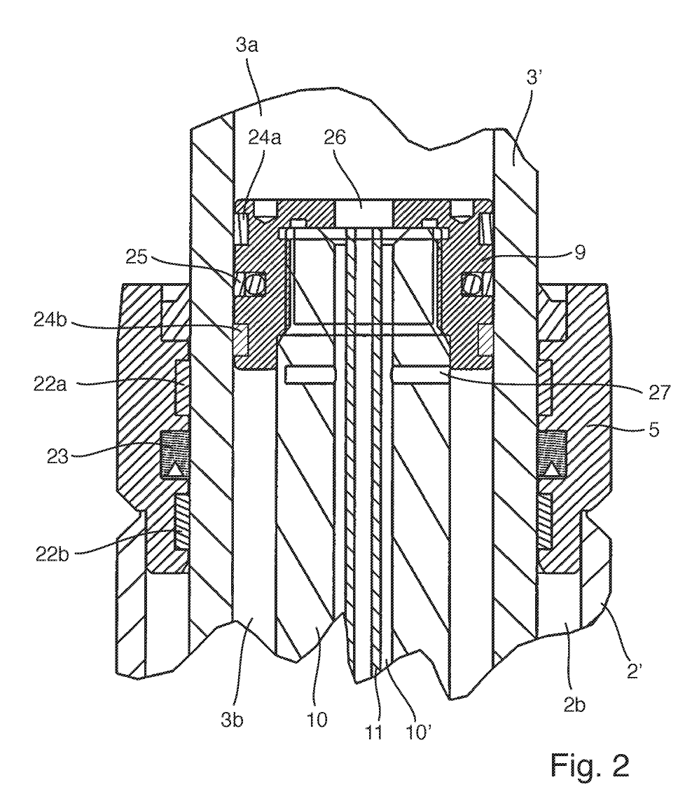

The section marked detail A in FIG. 1 is shown enlarged in FIG. 2. In this detail the cylinder head 5 of the outer hydraulic cylinder 2 is shown with an inner hydraulic cylinder 3 sealed and displaceable in reference to the cylinder head 5. The cylinder head 5 comprises for this purpose a sealing system with a doctor 21, two guide grooves 22a, 22b, and an annular gasket 23 arranged therebetween. The doctor 21 serves during the insertion of the inner hydraulic cylinder 3 to remove dirt, contaminants, chips, and moisture from the exterior of the cylinder wall 3′ of the inner hydraulic cylinder 3. The guide rings 22a, 22b serve as friction bearings and guide the inner hydraulic cylinder 3 in the cylinder head 5 of the outer hydraulic cylinder 2. They prevent the direct contact of metal to metal and this way they prevent wear and tear. Such guide rings 22a, 22b can be produced for example from laminated fabric or PTFE.

A piston 9 is arranged in a longitudinally displaceable fashion in the inner chamber of the inner hydraulic cylinder 3. It is hydraulically sealed against the inner wall of the hydraulic cylinder 3 via a sealing system comprising two guide rings 24a, 24b and a piston seal 25. At its side facing downwards in the direction of the cylinder chamber 3b the piston 9 carries a piston rod 10 provided with a longitudinal bore hole 10′. The hydraulic line 11 is arranged inside the longitudinal bore hole 10′. The hydraulic line 11 is connected in a fluid-guiding fashion via a central bore hole 26 in the piston 9 to the upper cylinder chamber 3a of the hydraulic cylinder 3. The remaining annular gap of the longitudinal bore hole 10′ about the hydraulic line 11 is connected via a lateral bore hole 27 in the piston rod 10 directly underneath the piston 9 to the lower cylinder chamber 3b such that through the longitudinal bore hole 10′ hydraulic fluid can also drain out of the lower cylinder chamber 3b and/or in an upward motion of the piston 9 be supplied thereto. This way, both the supply of hydraulic means as well as the drainage of hydraulic means can occur through the same longitudinal bore hole 10′ of the piston rod 10 from the lower end piece of the outer hydraulic cylinder 2. In addition to a coaxial conduit as in the exemplary embodiment shown, alternatively of course also two off-set longitudinal bore holes may be provided for the upper and the lower cylinder chamber 3a, 3b in the piston rod 10, or the hydraulic connection for the upper cylinder chamber 3a of the inner hydraulic cylinder 3 can be arranged in the upper end piece 8.

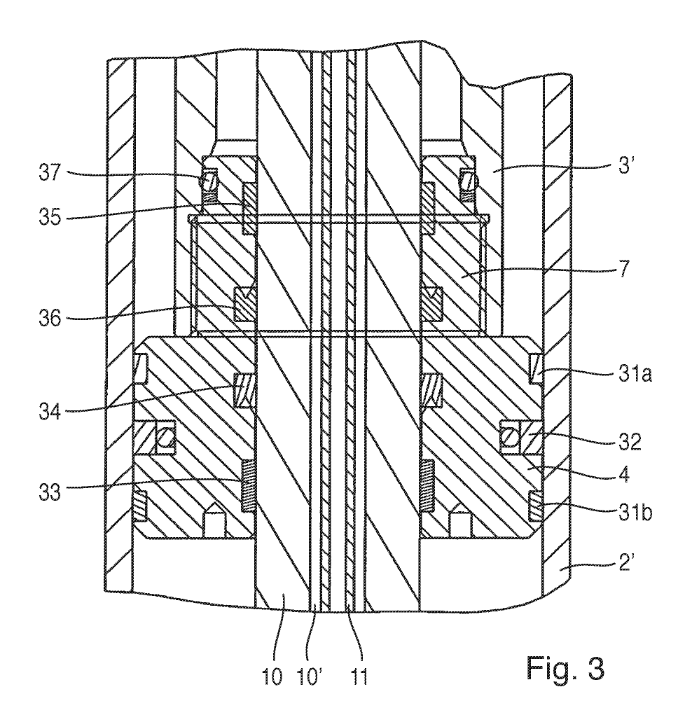

The section shown in FIG. 1 as detail B is shown enlarged in FIG. 3. It shows the piston 6 of the outer hydraulic cylinder 2 with the cylinder head 7 of the inner hydraulic cylinder 3 arranged at the side of the piston 6 facing upwards. The piston 6 is supported in a sealing fashion towards the interior of the cylinder wall 2′ of the outer hydraulic cylinder 2. For this purpose two guide rings 31a, 31b are provided, as well as a central piston seal 32. Both the piston 6 as well as the cylinder head 7 arranged thereon of the inner hydraulic cylinder comprise a central longitudinal bore hole, through which the piston rod 10 extends. In reference to the piston 6, the piston rod 10 is supported in a gliding fashion via a guide ring 33 and hydraulically sealed via a piston rod gasket 34. Another piston rod gasket 36 and a guide ring 35 seal and/or support the piston rod 10 towards the cylinder head 7 of the inner hydraulic cylinder 3. An O-ring 37 seals the cylinder head 7 against the cylinder tube 3′ of the inner hydraulic cylinder 3 in a static fashion.

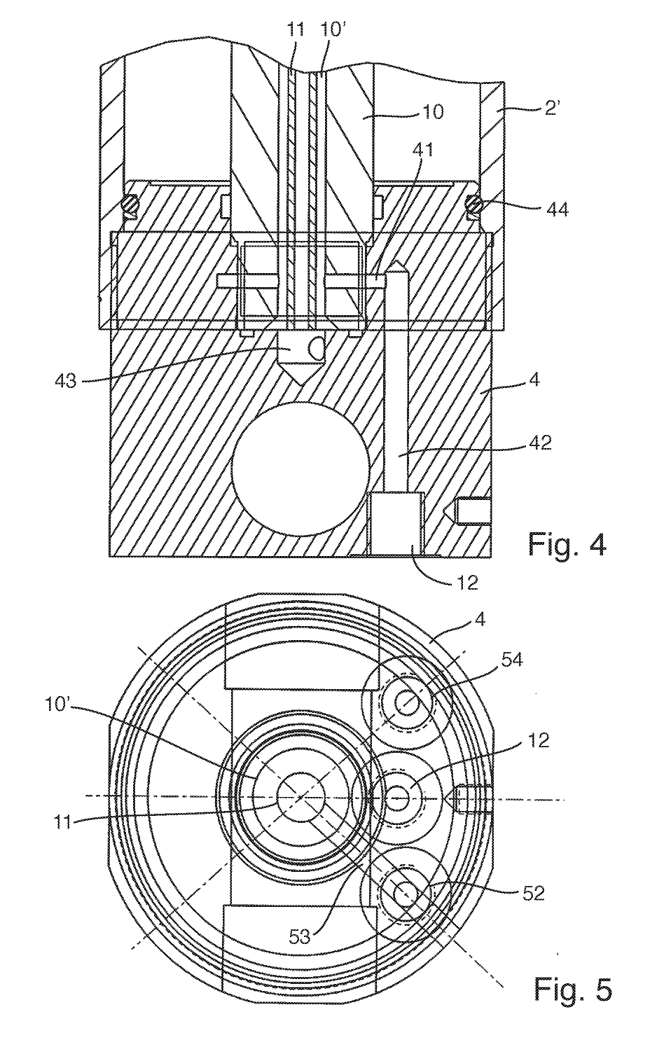

The section marked detail C in FIG. 1 finally is shown enlarged in FIG. 4. It illustrates the bottom end piece 5 of the outer hydraulic cylinder 2 connected to the piston rod 10 of the inner hydraulic cylinder 3. The outer cylinder tube 2′ is sealed via an O-ring 40 towards the bottom end piece 4. The piston rod 10 leads to an appropriate seat of the end piece 4. Here the longitudinal bore hole 10′ is connected via a radially extending bore hole 41 or alternatively a circularly machined annular groove to a longitudinal bore hole 42, which ends in the hydraulic connection 12 provided with an internal thread. The hydraulic line 11 extending inside the longitudinal bore hole 10′ends further downwards in a blind bore 43 in which a radial bore hole (not shown) ends, extending diagonally to the drawing level, which leads to another hydraulic connection.

An illustration of the cylinder/piston unit 1 from the bottom is shown in FIG. 5. In addition to the hydraulic connection 12, which is connected via the longitudinal bore hole 10′ in the piston rod 10 to the lower cylinder chamber 3b of the inner hydraulic cylinder 2, here two additional hydraulic connections 52, 54 are discernible. The hydraulic connection 54 leads directly to the lower cylinder chamber 2a of the outer hydraulic cylinder 2. The hydraulic connection 52 is connected via the diagonally extending radial bore 53 to the hydraulic line 11 extending inside the longitudinal bore hole 10′ and thus serves as a hydraulic connection for the upper cylinder chamber 3a of the inner hydraulic cylinder 3.

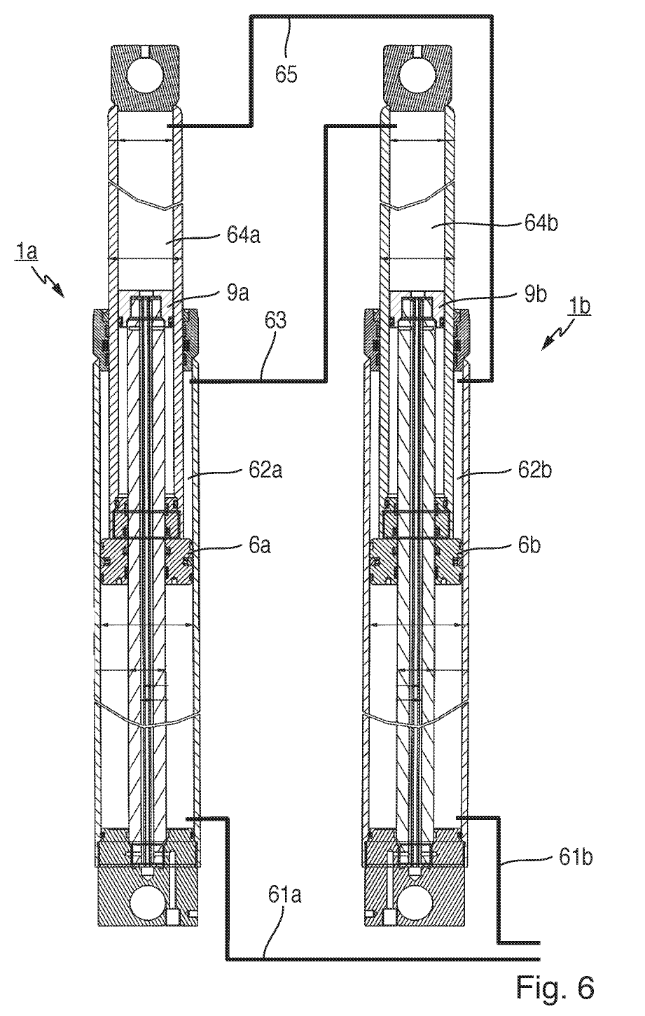

FIG. 6 finally shows schematically the connection of two cylinder/piston units 1a, 1b according to the invention forming a master/slave arrangement. The lower cylinder chamber of the outer hydraulic cylinder of the two cylinder/piston units 1a, 12b is respectively connected via a hydraulic line 61a, 61b to hydraulic circuits of a hydraulic pump separated via safety valves and/or return valves. The upper cylinder chamber 62a of the outer hydraulic cylinder of the left cylinder/piston unit 1a is connected via a hydraulic line 63 to the upper cylinder chamber 64b of the inner hydraulic cylinder of the right cylinder/piston unit 1b. Similarly, the upper cylinder chamber 62b of the outer hydraulic cylinder of the right cylinder/piston unit 1b is connected via a hydraulic line 65 to the upper cylinder chamber 64a of the inner hydraulic cylinder of the left cylinder/piston unit 1a. The hydraulic connection is here shown only schematically for reasons of clarity, since as explained above the hydraulic connections actually extend through the respective piston rods of the cylinder/piston units 1a, 1b and are guided towards the bottom end piece of the respectively outer hydraulic cylinder.

When pressure is applied via the hydraulic supply lines 61a, 62b upon the respectively outer hydraulic cylinder of the two cylinder/piston units 1a, 1b, here their pistons 6a, 6b are pushed upwards. Above the pistons 6a, 6b respectively hydraulic fluid is displaced, which is supplied via the hydraulic lines 63, 65 to the inner hydraulic cylinders of the respectively other cylinder/piston unit. Due to the fact that the hydraulically acting areas of the inner and outer hydraulic cylinders of the two cylinder/piston units 1a, 1b are adjusted to each other, the two pistons 9a, 9b of the respective inner hydraulic cylinders are also displaced downwards by the same distance as the respective pistons 6a, 6b of the outer hydraulic cylinders move upwards. The hydraulic fluid displaced by the two inner pistons 9a, 9b flows via an appropriate hydraulic line (not shown) back into a hydraulic means reservoir.

When one of the hydraulic supply lines 61a, 61b loses pressure due to a defect, here the master/slave arrangement connected crosswise prevents the insertion of the cylinder/piston unit affected by the hydraulic effect, because its inner hydraulic cylinder, being the slave cylinder of the cylinder/piston unit not affected by the defect, it is still supplied with hydraulic pressure. Details of the connection embodied as a master/slave arrangement with respective safety and return valves are discernible from the publication DE29916254U1 of the applicant mentioned at the outset and particularly FIG. 2 illustrated there, which is hereby referenced in its entire content to avoid unnecessary repetitions.

In another exemplary embodiment, two hydraulic cylinders, i.e. an outer and an inner one, are also coaxially integrated in a cylinder/piston unit. The inner hydraulic cylinder is arranged inside the outer hydraulic cylinder and connected to its cylinder bottom. The outer hydraulic cylinder is therefore arranged coaxially about the inner hydraulic cylinder.

The outer hydraulic cylinder comprises an annular piston, which is arranged inside the outer hydraulic cylinder, to the annular chamber around the inner hydraulic cylinder, in a longitudinally mobile fashion and sealed both towards the inner wall of the outer hydraulic cylinder as well as the outer wall of the inner hydraulic cylinder. The piston of the outer hydraulic cylinder carries a tubular piston rod, with its inner diameter being greater than the outer diameter of the inner hydraulic cylinder.

A piston is also supported in a longitudinally displaceable fashion inside the inner hydraulic cylinder and sealed towards the inner wall of the inner hydraulic cylinder. The piston of the inner hydraulic cylinder also carries a piston rod, which is connected at its end distant from the piston to the end of the tubular piston rod of the outer hydraulic cylinder. This way, the inner and the outer hydraulic cylinder are also mandatorily synchronized with each other and serve as redundant units of the cylinder/piston units.

Similar to the first exemplary embodiment, the hydraulically effective areas of the annular piston of the outer hydraulic cylinder and the piston are adjusted to the side of the inner hydraulic cylinder facing away from the piston rod such that in an arrangement of two or more such cylinder/piston units the inner hydraulic cylinder of a first cylinder/piston unit can be connected as a slave cylinder of the outer cylinder of a second cylinder/piston unit.

The hydraulic connections for the respective cylinder chamber located underneath the piston can respectively be arranged at the cylinder bottom, the hydraulic connection of the cylinder chamber located above the piston of the outer hydraulic cylinder, similar to the first exemplary embodiment, can be guided at the outer wall of the outer hydraulic cylinder and the hydraulic connection of the cylinder chamber located above the piston of the inner hydraulic cylinder, similar to the first exemplary embodiment, guided through the piston rod to the cylinder bottom.

1. A cylinder/piston unit comprising a first outer hydraulic cylinder (2) in which a first piston (6) is arranged in a sealed fashion, the first piston (6) is longitudinally movable in reference to a cylinder inner wall (2′) of the first hydraulic cylinder (2), the first piston (6) carries a second inner hydraulic cylinder (3), in which a second piston (9) is arranged in a sealed fashion, and the second piston (9) is longitudinally movable in reference to a cylinder inner wall (3′) of the second hydraulic cylinder (3), the second piston (9) carries a piston rod (10), with the piston rod (10) being connected at an end thereof, distant from the second piston (9), to an end (5) of the outer hydraulic cylinder (2), a hydraulically effective area of the first piston (6) is equivalent on a side of the first piston facing the second hydraulic cylinder (3) to a hydraulically acting area of the second piston (9) at a side of the second piston facing away from the piston rod (10).

2. The cylinder/piston unit according to claim 1, wherein the piston rod (10) extends through the first piston (6) in a longitudinally movable fashion and is sealed in reference thereto.

3. The cylinder/piston unit according to claim 1, wherein each of the first and second hydraulic cylinders (2, 3) comprise in proximity of respectively corresponding end positions of at least one of the first or second pistons (4, 9) an overflow channel, via which hydraulic medium is adapted to flow out of the pressurized cylinder chamber (2a, 3a) at one side of the respective piston (4, 9) to a cylinder chamber (2b, 3b) located on the a respective other side of the respective piston (4, 9) or to a hydraulic connection connected thereto.

4. The cylinder/piston unit according to claim 1, wherein the piston rod (10) comprises at least one longitudinal bore hole (10′) through which a first hydraulic connection (12) extends connected to a cylinder chamber (3a) of the second hydraulic cylinder (3) located at the side facing away from the piston rod (10).

5. The cylinder/piston unit according to claim 5, wherein a second hydraulic connection (42) extends through the longitudinal bore hole (10′) or another bore hole in the piston rod (10), connected to a cylinder chamber (3b) of the second hydraulic cylinder (3) located at the side facing the piston rod (10).

6. The hydraulic arrangement comprising two of the cylinder/piston units (1a, 1b) according to claim 1, wherein the first and the second hydraulic cylinder of each of the two cylinder/piston units (1a, 1b) are respectively connected crosswise to each other in a fluid-guiding fashion such that respectively the second hydraulic cylinder operates as a slave cylinder of the first cylinder of the respective other of the cylinder/piston units in a master/slave arrangement.

7. The hydraulic arrangement according to claim 6, wherein a cylinder chamber (62a, 62b) of the first hydraulic cylinder of the first hydraulic cylinder of a first of the two cylinder/piston units (1a, 1b) is connected in a fluid-guiding fashion at the side of said first piston (6a, 6b), at the side facing the second hydraulic cylinder, to a cylinder chamber (64a, 64b) of the second hydraulic cylinder of a second of the two cylinder/piston units at the side of the second piston (9a, 9b) facing away from the piston rod.

8. A hoisting platform, comprising a hydraulic arrangement according to claim 7, wherein the two cylinder/piston units (1a, 1b) are connected to each other in a fluid-conducting fashion in order to form a hydraulic arrangement of two separate hoisting devices.

9. A hydraulic arrangement comprising at least one cylinder/piston unit (1) according to claim 1, wherein a cylinder chamber (2b) of the first hydraulic cylinder (2) is connected at the side of the first piston (6), facing the second hydraulic cylinder (3), to a cylinder chamber (3a) of the second hydraulic cylinder (3) at the side of the second piston (9) facing away from the piston rod (10).

10. A cylinder/piston unit comprising a first outer hydraulic cylinder and a second inner hydraulic cylinder, which are coaxially arranged and connected to each other at the bottom,
the first hydraulic cylinder comprises an annular first piston, which is arranged inside the first hydraulic cylinder in an annular chamber about the second hydraulic cylinder in a longitudinally movable fashion and sealed both against an inner wall of the first hydraulic cylinder as well as an outer wall of the second hydraulic cylinder,
the first piston of the first outer hydraulic cylinder carries a tubular first piston rod having an inner diameter that is greater than an outer diameter of the second inner hydraulic cylinder,
the second hydraulic cylinder includes a second piston that is arranged in a longitudinally movable fashion and sealed against an inner wall of the second hydraulic cylinder, and
the second piston of the second hydraulic cylinder carries a second piston rod, which is connected at an end thereof spaced apart from the second piston to an end of the tubular first piston rod of the first hydraulic cylinder.
